(19) United States
(12) Patent Application Publication
(10) Pub. No.: US 2010/0275126 A1
(43) Pub. Date: Oct. 28, 2010

(54) Automatic On-Screen Keyboard

(76) Inventor: Scott David Lincke, Rockville, MD (US)

Correspondence Address: WHITE-WELKER & WELKER, LLC, P.O. BOX 199, CLEAR SPRING, MD, 21722-0199, US

(21) Appl. No.: 12/757,167

(22) Filed: Apr. 9, 2010

Related U.S. Application Data
(60) Provisional application No. 61/172,804, filed on Apr. 27, 2009.

(51) Int. Cl. G06F 3/048; G06F 15/16

(52) U.S. Cl. 715/738; 715/773; 715/760

(57) ABSTRACT

Method for automatically controlling an on-screen keyboard to optimize its use with a current web page. When a web browser requests content from a web server by sending the URL of the content over its data connection, a client keyboard manager module detects this request and sends a second request with the content URL to the server keyboard control module running on a server. While the web server responds to the first request, the server keyboard control module running on separate server determines if preferred keyboard settings are stored for the URL information that it received from the client. If preferred keyboard settings are found, they are sent from the server keyboard control module to the client. The client keyboard manager module uses the received information to adjust the on-screen keyboard to reflect the preferred keyboard settings so that text entry is enabled with reduced user intervention.

### CROSS REFERENCE TO RELATED APPLICATIONS

This application claims priority from U.S. Provisional Patent Application Ser. No. 61/172,804, entitled “Automatic On-Screen Keyboard”, filed on 27 Apr. 2009. The benefit under 35 USC §119(e) of the United States provisional application is hereby claimed, and the aforementioned application is hereby incorporated herein by reference.

### FEDERALLY SPONSORED RESEARCH

Not Applicable

### SEQUENCE LISTING OR PROGRAM

Not Applicable

### TECHNICAL FIELD OF THE INVENTION

The present invention relates generally to software. More specifically, the present invention relates to a method of automatically managing an on-screen keyboard used with a web browser.

### BACKGROUND OF THE INVENTION

Prior art on-screen keyboards are generally used in situations where a physical keyboard is not convenient or by individuals challenged by the interaction required by physical keyboards. One shortcoming of the prior art on-screen keyboards is that they merely present a software-displayed keyboard on screen to allow users to enter text without a physical keyboard, but require manual activation to show or hide the keyboard, manual resizing of the keyboard, and/or manual placement of the keyboard to the desired location on the screen. These deficiencies cause a burden to the user by forcing the user to manually manage the keyboard in order to interact with it while having access to see the information displayed on the screen. Some prior art reduces this issue by presenting a semi-transparent keyboard; however this approach still obscures the user's view of the actual content on the screen. Other prior art automatically shows the keyboard when the user clicks in a text field, but places the keyboard in the same location on the screen regardless of the location of the text field; however this approach also still obscures the user's view of the screen more than is necessary or desired.

What is needed is a system-managed keyboard for use when a physical keyboard is not present or feasible that automatically controls the on-screen keyboard so that it is available and located in the right location, with the right size regardless of the content displayed. The solution should enable text input for fields on a screen that may display a wide variety of content such as the arbitrary set of web pages a viewer may visit. Such as solution would provide a distinct advantage over the prior art to those users that are disabled or those using less convenient input devices like touch screens or limited function remote controls.

Therefore what is needed is a method for automatically controlling an on-screen keyboard in a way which allows users to access various websites and enter text while obscuring the view of the screen as little as possible and requiring minimal manual user interaction.

### BRIEF SUMMARY OF THE INVENTION

The present invention is a method of automatically managing an on-screen keyboard used with a web browser. The present invention optimizes text input on a web page through an on-screen keyboard when a physical keyboard is not practical but a pointing device is available. The invention automatically enables and on-screen keyboard to appear when and where users are likely to need to use it.

The advantages of the present invention include, without limitation, the ease with which it allows users to access various websites and enter text on devices without easy access to a physical keyboard while obscuring the screen as little as possible and requiring minimal manual user interaction. This presents usability advantages over current on-screen keyboards that merely allow users to enter text without a physical keyboard, but require manual configuration, manual activation to show or hide the keyboard, manual sizing and/or manual placement of the keyboard to the desired location on the screen. It presents an even greater advantage for users that are challenged in interacting with the screen, such as the disabled or those using less convenient input devices like touch screens or limited function remote controls.

### BRIEF DESCRIPTION OF THE SEVERAL VIEWS OF THE DRAWING

The accompanying drawings, which are incorporated herein and form a part of the specification, illustrate the present invention and, together with the description, further serve to explain the principles of the invention and to enable a person skilled in the pertinent art to make and use the invention.

FIG. 1 is an overall software architecture view of the present invention;

FIG. 2 is a flow diagram illustrating the client and server processing of an automatic adjustment of the keyboard settings;

FIG. 3 is an illustration showing the controls used in manual adjustment of the keyboard settings;

FIG. 4 is a flow diagram illustrating the client and server processing of manual adjustment of the keyboard settings.

FIG. 5 illustrates an example web page, which includes a text entry field at a fixed location used by almost all visitors;

FIG. 6 illustrates an example web page, which includes a text entry field at a certain location used by only a small percentage of all visitors;

FIG. 7 illustrates an example web page which includes no text fields and so an on-screen keyboard is used by few or no visitors; and

FIG. 8 is a flow chart illustrating the process of the present invention for providing an automatic keyboard.

### DETAILED DESCRIPTION OF THE INVENTION

In the following are detailed descriptions of the invention of exemplary embodiments. These embodiments are described in sufficient detail to enable those skilled in the art to practice the invention, but other embodiments may be utilized and logical, mechanical, electrical, and other changes may be made without departing from the scope of the present invention. The following detailed description is, therefore, not to be taken in a limiting sense, and the scope of the present invention is defined only by the appended claims.

In the following description, numerous specific details are set forth to provide a thorough understanding of the invention. However, it is understood that the invention may be practiced without these specific details. In other instances, well-known structures and techniques known to one of ordinary skill in the art have not been shown in detail in order not to obscure the invention.

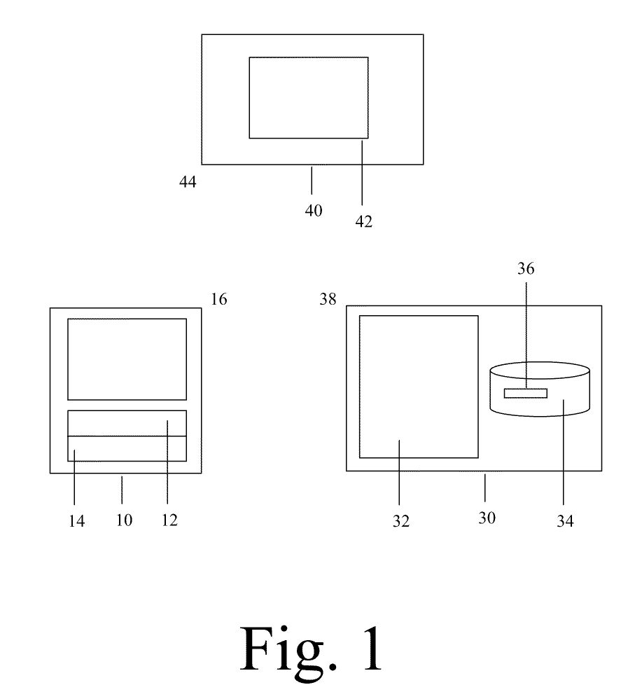

Referring now to the invention in more detail, in FIG. 1 there is shown a client-computing device 10 having a web browser 12, a client keyboard manager module 14, and a data connection 16. A server computing device 30 is also shown having a server keyboard control module 32, a data storage device 34, stored preferred keyboard settings 36 that includes URL-specific information about the keyboard placement location and visibility like whether the on-screen keyboard 50 should be automatically shown or hidden or set to appear automatically when the cursor is in a text field 52 on web browser 12, and a data connection 38 that allows it to send and receive messages to and from client computing device 10. Also, a web-server computing device 40 is shown with web server software 42 and a data connection 44 that allows it to send and receive messages to and from client computing device 10. The screen position specified for where the keyboard should be placed can be relative to screen size or absolute. Also it could be set to stay at a certain position on the display or set to move with the information as the screen is scrolled. Feedback messages may optionally be sent from the client to the server. These feedback messages provide information about how the user interacted with the on-screen keyboard and may be used to update the preferred keyboard setting for a given URL. Updates from the client to server as feedback can be sent immediately or delayed/batched and sent later. Updates from the client to server can be sent grouped with other info that may be related or unrelated to the keyboard information.

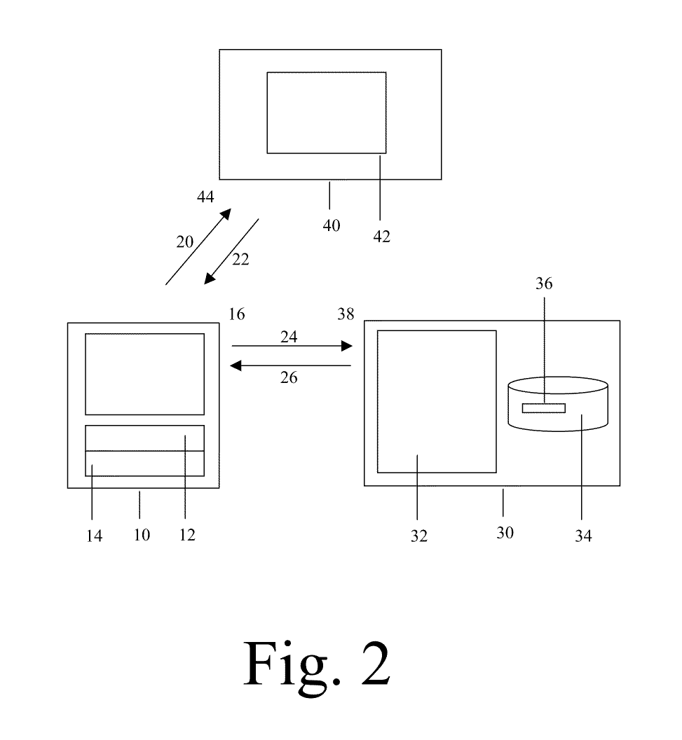

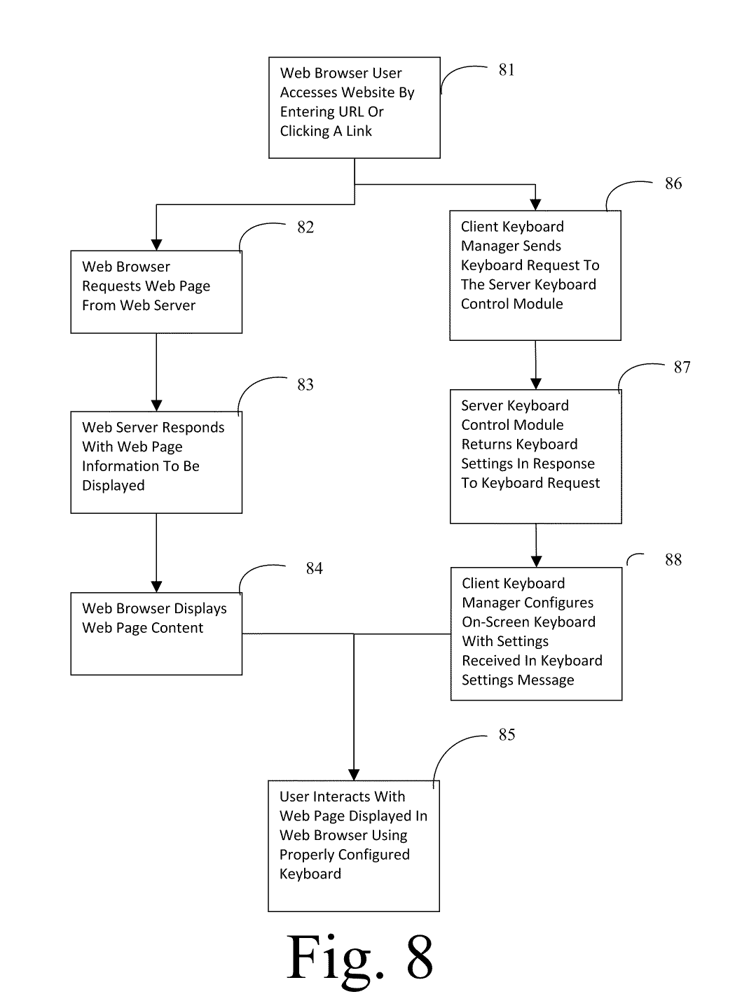

FIGS. 2 and 8 illustrate the automatic control of the on-screen keyboard 50. When a user of the client device 10 uses the web browser 12 to trigger the request of content from a web server computing device 40 by sending a web request 20, including the URL of the content, over its data connection 16 in step 81, the client keyboard manager module 14 detects this request and sends a keyboard request 24 with the content URL to the server keyboard control module 32 in step 86 running on server computing device 30. The web server-computing device 40 responds in step 83 to the request it received in steps 81 and 82 by sending the requested and retrieved content in web response 22 to client device 10 for processing by the web browser 12. The server keyboard control module 32, in step 87, running on server computing device 30 determines if preferred keyboard settings 36 are stored in data storage device 34 for the URL that it received from the client keyboard manager module 14. If preferred keyboard settings 36 are found, they are sent from the server keyboard control module 32 to the client keyboard manager module 14 running on client computing device 10 in the keyboard response 26 in step 87. If preferred keyboard settings 36 are not found, default settings are sent instead. The client keyboard manager module 14, in step 88, uses the received preferred keyboard settings 36 to configure the on-screen keyboard 50 to be shown, hidden, or set to appear automatically when the cursor is in a text field 52 on the web browser 12 content displayed in step 84. Finally, a user interacts with the web page displayed in the web browser using a properly configured keyboard in step 85. It also determines the location of the keyboard for its next appearance either at a specific location or so it appears at its last location on screen.

In an alternate embodiment of the invention, the server keyboard control module 32 and the data storage device 34 are located locally on the client device 10 so that preferred keyboard settings 36 can be retrieved without sending information over the network. In this case, the set of preferred keyboard settings 36 are loaded into the data storage device 34 during periodic data retrievals similar to how virus definition files are commonly distributed.

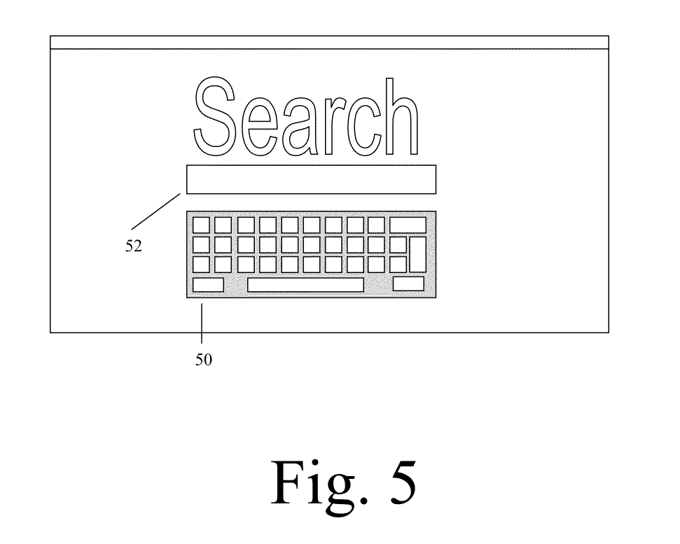

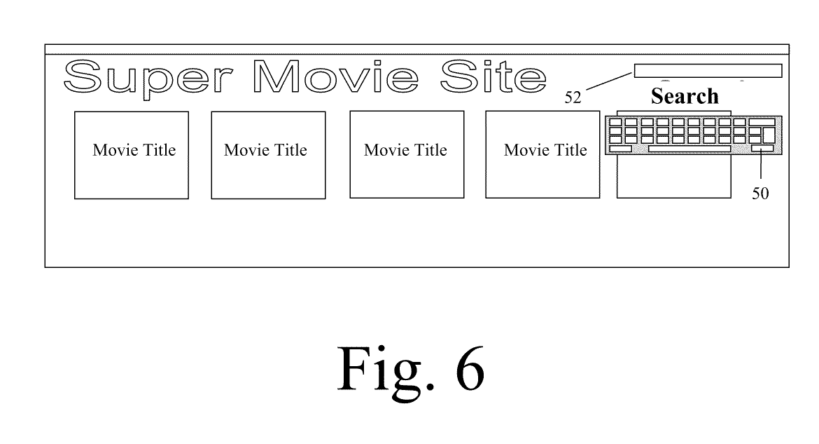

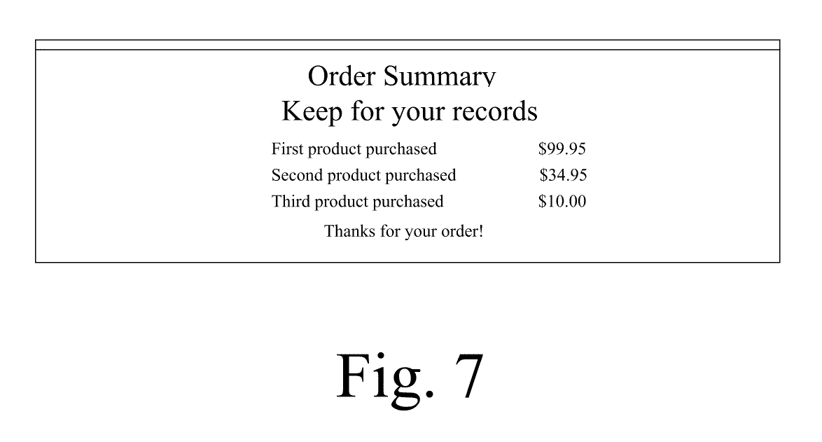

FIG. 5, FIG. 6, and FIG. 7 illustrate examples of web pages that can benefit from this invention. FIG. 5 illustrates a web page that includes only a single text field 52 that is used by nearly every visitor to the web page. In this case the preferred keyboard settings 36 stored in the data storage device 34 can include values to specify that the on-screen keyboard 50 should be automatically made visible and located directly under the text field 52. FIG. 6 illustrates a web page that includes only a single text field 52 that is used by few visitors to the web page, but those that do, require text entry. In this case the preferred keyboard settings 36 stored in the data storage device 34 can include values to specify that the on-screen keyboard 50 should be hidden but automatically made visible when the user clicks in the text box and then appear directly under the text field 52. FIG. 7 illustrates a web page that includes no text field 52, so users never require text entry on this page. In this case the preferred keyboard settings 36 stored in the data storage device 34 can include values to specify that the on-screen keyboard 50 should be hidden.

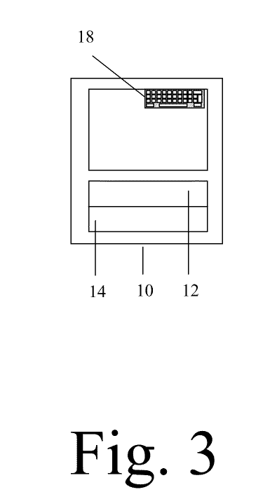

FIG. 3 illustrates that the manual keyboard control 18 includes one button to toggle the appearance on-screen keyboard 50 on the screen. This feature of the client keyboard manager module 14 allows users to manually show or hide the on-screen keyboard 50 in the web browser 12 running on the client computing device 10. When a user selects the button, the client keyboard manager module 14 detects the input and toggles the appearance of the on-screen keyboard 50 in the web browser 12 from visible to hidden or hidden to visible, depending on its current state.

In further detail, referring back to the invention of FIG. 1, the data connection speed, including both data bit-rate and latency, between client computing device 10 and server computing device 30 as well as the processing performance of the server keyboard control module 32 must be sufficient that the client keyboard manager module 14 is able to set the on-screen keyboard 50 to the preferred keyboard settings 36 in the web browser 12 quickly enough for the user to benefit. In addition to data connection speed, the processing performance of the server computing device 30 and the server data storage 34 must be adequate to respond to queries quickly.

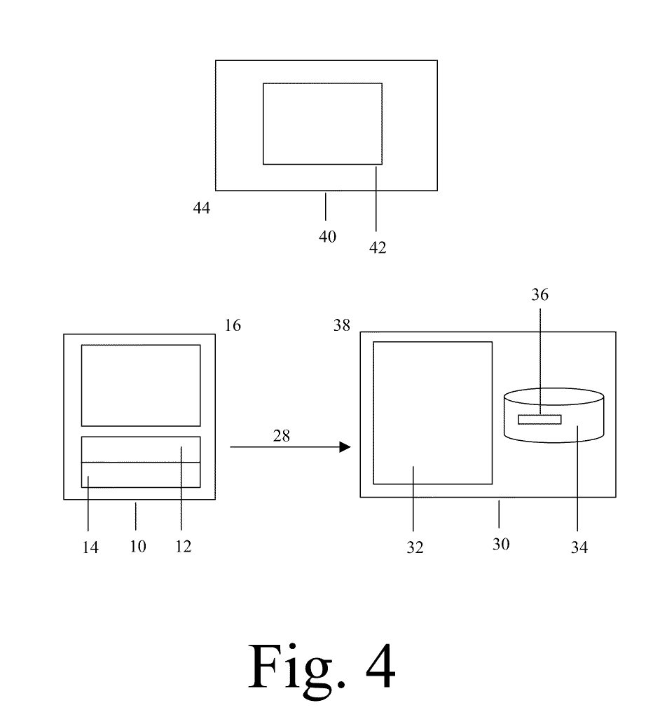

The construction details of the invention as shown in FIG. 1 illustrate a client keyboard manager module 14 that is separate from the web browser 12, but the client keyboard manager module 14 of course can be integrated into the web browser 12. The construction details, as shown in FIG. 1, illustrate a web browser 12 integration including access to web server software 42, but other client integration and access to other server sources of course could be used. The controls shown in FIG. 3 show a single keyboard icon button used for the manual keyboard control 18, but other on-screen controls and inputs, like a physical button on a remote control or mouse, of course could be used. The construction details shown in FIG. 2 show preferred keyboard settings 36 specific to a URL, but less specific web location information like a domain name could of course also be used. FIG. 4 illustrates an optional refinement of the invention in which manual use of the keyboard control 18 is sent in a keyboard feedback message 28 to the server keyboard control module 32 so it can update the preferred keyboard settings 36 with the screen location so that this information can be later be used as the preferred keyboard settings 36 for use by this or other users.

Thus, it is appreciated that the optimum dimensional relationships for the parts of the invention, to include variation in size, materials, shape, form, function, and manner of operation, assembly and use, are deemed readily apparent and obvious to one of ordinary skill in the art, and all equivalent relationships to those illustrated in the drawings and described in the above description are intended to be encompassed by the present invention. Furthermore, other areas of art may benefit from this method and adjustments to the design are anticipated. Thus, the scope of the invention should be determined by the appended claims and their legal equivalents, rather than by the examples given.

I claim:

1. A computer readable medium having computer executable instructions, that when executed by a computer causes the computer to perform a method for displaying an automatic on-screen keyboard comprising:
providing a client computing device having a web browser;
providing a client keyboard manager module;
providing a data connection;
providing a server computing device having a server keyboard control module;
providing a data storage device;
storing preferred keyboard settings on the data storage device;
providing a data connection between the client computing device and the server computing device;
sending and receiving messages to and from the client computing device and the server computing device;
providing a web-server computing device with a web server software;
allowing the web-server computing device to send and receive messages to and from the client computing device via the data connection; and
specifying the screen position location for the keyboard.

2. The method for displaying an automatic on-screen keyboard of claim 1, further comprising the steps of:
sending a web request, including the URL of the content over the data connection by the web browser;
requesting content from the web server computing device over the data connection;
detecting the request by the client keyboard manager;
sending a keyboard request with the content URL to the server keyboard control module running on the server computing device by the client keyboard manager;
responding by the web server computing device to the request;
sending the requested and retrieved content in a web response by the web server computing device to the client device for processing by the web browser;
determining by the server keyboard control module running on the server computing device if preferred keyboard settings are stored in the data storage device for the URL that was received from the client keyboard manager module;
if the preferred keyboard settings are found, they are sent from the server keyboard control module to the client keyboard manager module running on the client computing device in the keyboard response; and
if the preferred keyboard settings are not found, default settings are sent;
using the received preferred keyboard settings by the client keyboard manager module to configure the on-screen keyboard to be shown, hidden, or set to appear automatically when the cursor is in a text field on the web browser content displayed; and
interacting with the web page displayed in the web browser using a properly configured keyboard.

3. The method for displaying an automatic on-screen keyboard of claim 2, further comprising the step of:
determining the location of the keyboard for its next appearance; and
placing the location of the keyboard by the client keyboard manager module either at a specific location or at its last location on screen.

4. The method for displaying an automatic on-screen keyboard of claim 1, further comprising the step of:
specifying the screen position location and size for the keyboard as a proportion of the total screen; or
specifying the screen position location and size for the keyboard as a proportion of the total screen using screen coordinates.

5. The method for displaying an automatic on-screen keyboard of claim 4, further comprising the steps of:
specifying the screen position location for the keyboard to stay at a certain position on the display; or
specifying the screen position location for the keyboard to move with the information as the screen is scrolled.

6. The method for displaying an automatic on-screen keyboard of claim 1, further comprising the steps of:
sending feedback messages from the client to the server;
providing information about how the user interacts with the on-screen keyboard via the feedback messages; and
using the provided information to update the preferred keyboard setting for a given URL.

7. The method for displaying an automatic on-screen keyboard of claim 6, further comprising the step of:
updating from the client to the server as the feedback is received.

8. The method for displaying an automatic on-screen keyboard of claim 7, further comprising the steps of:
sending either immediately or delayed/batched feedback to the server; and
sending updates from the client to the server either grouped with other information that may be related or unrelated to the keyboard information.

9. The method for displaying an automatic on-screen keyboard of claim 1, further comprising the step of:
storing preferred keyboard settings that includes URL-specific information about the keyboard placement, location, and visibility by the data storage device.

10. The method for displaying an automatic on-screen keyboard of claim 9, wherein
the on-screen keyboard is either automatically shown or hidden or set to appear automatically when the cursor is in a text field on web browser.

11. The method for displaying an automatic on-screen keyboard of claim 1, further comprising the steps of:
locating locally the server keyboard control module and the data storage device on the client device;
sending a web request, including the URL of the content over the data connection by the web browser;
requesting content from the web server computing device over the data connection;
detecting the request by the client keyboard manager;
sending a keyboard request with the content URL to the server keyboard control module running on the local client device by the client keyboard manager;
responding by the web server computing device to the request;
sending the requested and retrieved content in a web response by the web server computing device to the client device for processing by the web browser;
determining by the server keyboard control module running on the local client device if preferred keyboard settings are stored in the data storage device for the URL that was received from the client keyboard manager module;
if the preferred keyboard settings are found, they are sent from the server keyboard control module to the client keyboard manager module running on the client computing device in the keyboard response;
using the received preferred keyboard settings by the client keyboard manager module to configure the on-screen keyboard to be shown, hidden, or set to appear automatically when the cursor is in a text field on the web browser content displayed;
interacting with the web page displayed in the web browser using a properly configured keyboard;
retrieving the preferred keyboard settings without sending information over a network; and
loading the set of preferred keyboard settings into the data storage device during periodic data retrievals.

12. The method for displaying an automatic on-screen keyboard of claim 1, further comprising the steps of:
detecting a web page that includes at least one text field that is used by nearly every visitor to the web page; and
providing a preferred keyboard setting stored in the data storage device that includes values to specify that; and
automatically making the on-screen keyboard visible and located directly under the text field.

13. The method for displaying an automatic on-screen keyboard of claim 1, further comprising the steps of:
detecting a web page that includes at least one text field that is used by few visitors to the web page, but those that do, require text entry;
providing a preferred keyboard setting stored in the data storage device that includes values to specify;
that the on-screen keyboard should be hidden; and
that the on-screen keyboard automatically be made visible when the user clicks in the text box and appear directly under the text field.

14. The method for displaying an automatic on-screen keyboard of claim 1, further comprising the steps of:
detecting a web page that includes no text field; and
hiding the on-screen keyboard.

15. The method for displaying an automatic on-screen keyboard of claim 1, further comprising the steps of:
providing manual keyboard control;
displaying one control button to toggle the appearance of the on-screen keyboard on the screen in the web browser running on the client computing device; and
selecting the control, the client keyboard manager module detects the input and toggles the appearance of the on-screen keyboard in the web browser from visible to hidden or hidden to visible, depending on its current state.

16. The method for displaying an automatic on-screen keyboard of claim 15, wherein other on-screen controls and physical inputs are provided as a means for manual keyboard control.

17. The method for displaying an automatic on-screen keyboard of claim 1, wherein the client keyboard manager module is integrated into the web browser.

18. The method for displaying an automatic on-screen keyboard of claim 1, further comprising the step of:
storing preferred keyboard settings that includes non-URL-specific information about the keyboard placement location and visibility by the data storage device

19. The method for displaying an automatic on-screen keyboard of claim 1, further comprising the steps of:
submitting, in a keyboard feedback message to the server keyboard control module, manual use of the keyboard control; and
updating the preferred keyboard settings with the screen location, by the server keyboard control module, so that this information can be used as the preferred keyboard settings.

20. The method for providing an automatic on-screen keyboard of claim 1, further comprising the steps of:
using the web browser to trigger a request of content from a web server computing device;
sending a web request by the web browser, including the URL of the content, over the webs browser's data connection;
detecting this request by the client keyboard manager module;
sending a keyboard request with the content URL to the server keyboard control module running on the server computing device;
responding to the request by the web server computing device;
sending the requested content in a web response to a client device for processing by the web browser;
determining by the server keyboard control module running on server computing device if preferred keyboard settings are stored in the data storage device for the URL that it received from the client keyboard manager module;
sending preferred keyboard settings from the server keyboard control module to the client keyboard manager module running on client computing device in the keyboard response if they are found; and
using the received preferred keyboard settings by the client keyboard manager module to configure the on-screen keyboard to be shown, hidden, or set to appear automatically when the cursor is in a text field on web browser.
